(19) United States
(12) Patent Application Publication
(10) Pub. No.: US 2016/0275119 A1
(43) Pub. Date: Sep. 22, 2016

(54) BUILDING INFORMATION PROCESSING DEVICE, BUILDING INFORMATION PROCESSING METHOD, AND NON-TRANSITORY COMPUTER READABLE MEDIUM

(71) Applicant: KABUSHIKI KAISHA TOSHIBA, Tokyo (JP)

(72) Inventor: Mikito IWAMASA, Tokyo (JP)

(21) Appl. No.: 15/068,027

(22) Filed: Mar. 11, 2016

(30) Foreign Application Priority Data
Mar. 20, 2015 (JP) 2015-058610

(51) Int. Cl. G06F 17/30

(52) U.S. Cl. CPC G06F 17/30336; G06F 17/30477; G06F 17/30377

(57) ABSTRACT

A building information processing device includes: a database, a searcher, an extractor, a corrector and a combiner. The searcher searches the database for first records based on an inquiry index including a value of at least one attributes. The extractor extracts a first difference indicating a value of the attribute that is present in the inquiry index but not in the index included in the first record, and a second difference indicating a value of the attribute that is not present in the inquiry index but is present in the index. The corrector generates corrected indices by replacing the second difference in the index by the first difference, and calculates data of the corrected indices based on the first difference and the second difference. The combiner generates a combined index by combining the corrected indices, and calculates data of the combined index based on the data of the corrected indices.

### CROSS-REFERENCE TO RELATED APPLICATIONS

This application is based upon and claims the benefit of priority from Japanese Patent Application No. 2015-58610, filed Mar. 20, 2015; the entire contents of which are incorporated herein by reference.

### FIELD

An embodiment of the present invention relates to a building information processing device, a building information processing method, and a computer program.

### BACKGROUND

According to a conventional search technique, search for building information is performed according to relationships between components defined by IFC (Industry Foundation Classes, ISO16739) or CAD. The building information includes structural information (for example, a building includes 1F and 2F, and 1F includes room 1, room 2, door 1, floor 1, . . . , etc.), semantic structural information (for example, room 2 and door 1 are connected, and floor 1 is in contact with room 2, etc.), attribute information (attributes of components such as a room, a floor, etc.), and the like. The above-mentioned search is performed by using the relationships between components indicated by these pieces of information.

In recent years, there is a demand to evaluate data (performance, etc.) of a building even if, when conditions of a building are specified using building information, a building completely satisfying the conditions does not exist. However, conventionally, although search for a building matching a relationship of components may be performed by using the relationship, evaluation as described above cannot be performed.

### BRIEF DESCRIPTION OF THE DRAWINGS

FIG. 1 is a diagram showing a building information processing system including a building information processing device according to an embodiment of the present invention;

FIG. 2 is a diagram showing an example structure of a record in a building information DB;

FIGS. 3A and 3B are diagrams for describing processing by a corrector;

FIG. 4 is a diagram showing an overall operation sequence according to a first embodiment;

FIG. 5 is a diagram showing a flowchart of processing by the corrector;

FIG. 6 is a diagram showing a flowchart of processing by a building information combiner; and

FIG. 7 is a diagram showing an example hardware configuration of the building information processing device.

### DETAILED DESCRIPTION

According to one embodiment, a building information processing device comprising a computer including a processor, is provided. The building information processing device includes: a building information database, a building information searcher, a difference extractor, a corrector and a building information combiner.

The building information database is configured to store, for a plurality of buildings, a plurality of records each including an index and data, the data including values of a plurality of attributes.

The building information searcher, which is implemented by the computer, searches the building information database for first records based on an inquiry index including a value of at least one attributes among the plurality of attributes;

The difference extractor, which is implemented by the computer, extracts, with respect to each of the first records, a first difference indicating a value of the attribute that is present in the inquiry index but not in the index included in the first record, and a second difference indicating a value of the attribute that is not present in the inquiry index but is present in the index.

The corrector, which is implemented by the computer, generates corrected indices by replacing the second difference in the index by the first difference, and calculates data of the corrected indices based on the first difference and the second difference and by using the building information database.

The building information combiner, which is implemented by the computer, generates a combined index by combining the corrected indices, and calculates data of the combined index based on the data of the corrected indices.

Hereinafter, embodiments of the present invention will be described with reference to the drawings.

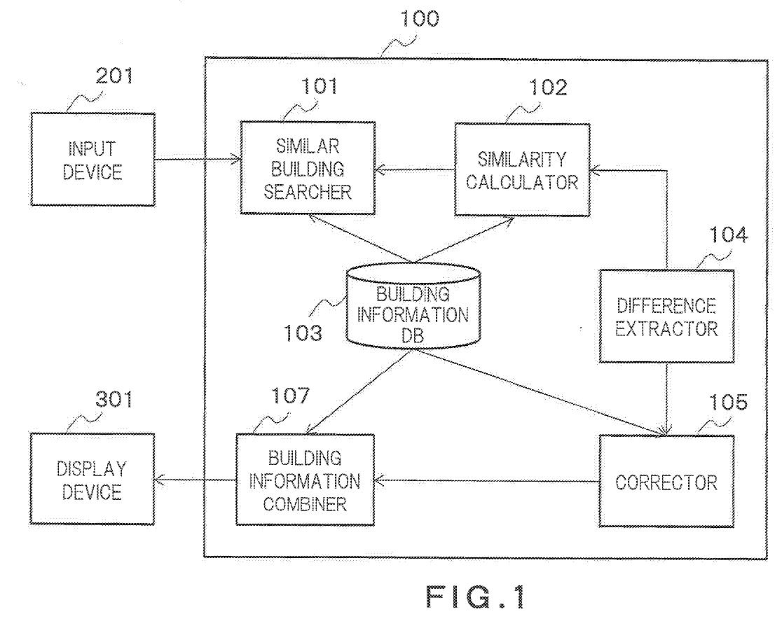

FIG. 1 shows a building information processing system (hereinafter “system”) including a building information processing device according to an embodiment of the present invention.

This system includes a building information processing device 100, an input device 201, and a display device 301. The building information processing device 100 includes a similar building searcher 101, a similarity calculator 102, a building information DB 103, a difference extractor 104, a corrector 105, and a building information combiner 107.

The building information DB 103 is a database storing a building information model about a building. The building information model expresses information about a building in one record for each building, and stores records of the number of buildings. Information about a building includes an index including a plurality of attributes indicating the properties or characteristics of a building and values of the attributes, data about performance of the building, structure information of the building (a 3D model, a simulation model, etc.), and the like.

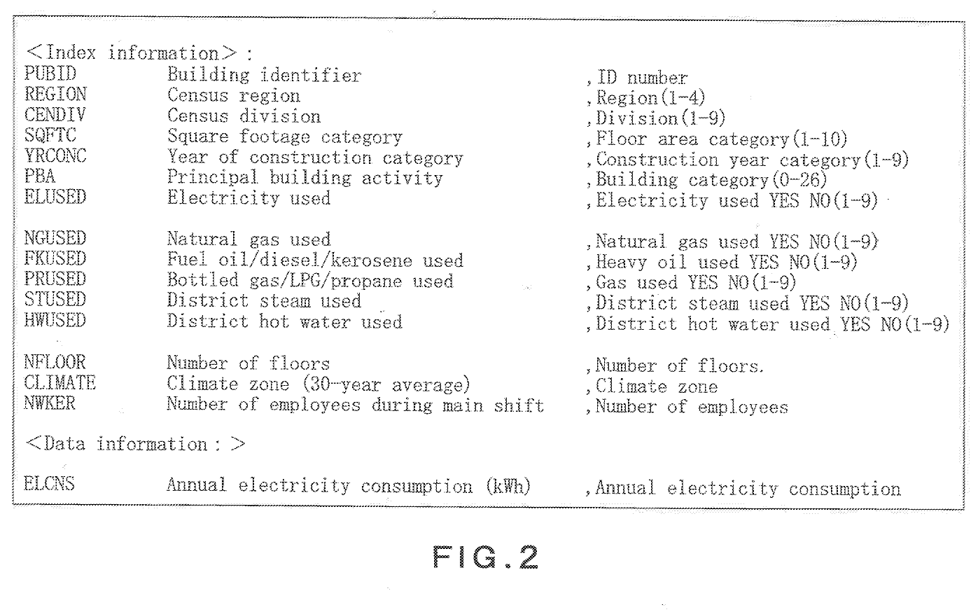

FIG. 2 shows an example of a record structure of the building information DB 103. In the present example, one record includes an index and data about one building. The index includes attributes of the building and values thereof. The data includes information about energy consumption and the like of the building, performance of the building, and the like. The index may be used for search. Here, the index includes 15 items, but in reality, the number of items may be more or less. In this case, annual electricity consumption is recorded as the data about energy consumption.

The input device 201 is an interface for inputting an inquiry index (search formula) including at least one attribute of a building and a value thereof for which search is desired to be performed. For example, the input device 201 may be an interface to be operated by a user, such as using a touch panel, a mouse, and a keyboard, a storage device storing an inquiry index, a read drive for reading data from a recording medium, or the like. The storage device may be a device or a non-volatile memory that permanently stores information, such as an SSD, a hard disk, and a USB memory, or a volatile memory, such as a DRAM. For example, the read drive is a drive for a DVD, a CD-ROM, or the like.

The similar building searcher 101 searches the building information DB 103 based on an inquiry index input from the input device 201. In the case where there is an index having an attribute value matching the inquiry index, building information of the building having the index is displayed by the display device 301. If there is no index having a matching attribute value, the degree of similarity to the inquiry index is calculated by the similarity calculator 102 for each record in the building information DB 103. The degree of similarity indicates the degree to which the inquiry index and the index of each record are approximate with each other. Of the records, one or a plurality of records whose degrees of similarity satisfy a pre-set condition are selected as similar records.

The display device 301 is a display that displays information. For example, the display device 301 is a liquid crystal display, or a display using any other display elements. A single, independent display, or a display of a mobile terminal may be used.

The difference extractor 104 calculates the difference between an index of a similar record and the inquiry index. Specifically, a set of an attribute which is present in the inquiry index but not in the index of the similar record and the value of the attribute is identified as a first difference, and a set of an attribute which is not present in the inquiry index but is present in the index of the similar record and the value of the attribute is identified as a second difference. An attribute which is common to the two and the value of the attribute may alternatively be identified.

The corrector 105 generates a corrected record by replacing the second difference by the first difference for the index of the similar record. Also, data (in this case, the annual electricity consumption) of the corrected record is calculated based on the first difference, the second difference, and each record in the building information DB 103. Generation of a corrected record and calculation of data are performed for each similar record. Details of methods of generation of a corrected record and calculation of data will be given later.

The building information combiner 107 combines corrected records, and generates a combined record. Also, data (annual electricity consumption) of the generated combined record is calculated. Details of a method of generation of a combined record and a method of calculation of data will be given later. The combined record and data thereof are displayed by the display device 301. A user checks the combined record and the data displayed by the display device 301 as a reply to the inquiry.

In the following, the present embodiment will be described in further detail with reference to a specific case.

The input device 201 inputs an inquiry index for search. An inquiry index includes at least one attribute and a value thereof. In the example in FIG. 2, there exist 15 attributes, and at least part or all of the attributes and values thereof are included. The inquiry index is configured as a search string including an attribute name and the value.

For example, in the case of “REGION=3 CENDIV=5 SQFTC=7 YRCONC=4 PBA=2 ELUSED=1 NGUSED=2 FKUSED=1 PRUSED=2 STUSED=2 HWUSED=2”, the character string of the inquiry index is “REGION3 CENDIV5 SQFTC7 YRCONC4 PBA2 ELUSED1 NGUSED2 FKUSED1 PRUSED2 STUSED2 HWUSED2”. That is, terms coupling attribute names and values are arranged with a space or the like therebetween to obtain one string (sentence). In this example, of the 15 items in the index, 11 items are used. The input device 201 may receive input of an index in this form and input the same to the main device, or it may receive input of data in the form of “attribute=value, attribute=value, . . . ”, convert the same into the form of an inquiry index, and input the same to the main device.

The similarity calculator 102 calculates the degree of similarity between the inquiry index and the index of a specified record. As a method for calculating the degree of similarity between indices, a method of defining a distance between indices and of measuring the degree of similarity in the distance size is conceivable, for example. Here, description is given by using a TF/IDF, which is one method of weighting terms in a sentence.

Like the inquiry index, the index of a specified record is assumed to be one string (sentence) in which terms coupling attribute names and values of the index of the record of building information are arranged with a space or the like therebetween. For example, if “REGION=3, CENDIV=5, SQFTC=7, YRCONC=4, PBA=2, ELUSED=1, NGUSED=2, FKUSED=1, PRUSED=2, STUSED=2, HWUSED=2, NFLOOR=4, CLIMATE=5,NWKER=300”, this is encoded, and an index “REGION3 CENDIV5 SQFTC7 YRCONC4 PBA2 ELUSED1 NGUSED2 FKUSED1 PRUSED2 STUSED2 HWUSED2 NFLOOR4 CLIMATE5 NWKER300” is obtained.

In the present embodiment, the degree of similarity between indices is calculated from the frequency of appearance of a term in a sentence.

### TF (Term Frequency)

TF_ij=Frequency of appearance of term i in sentence D_j/total number of terms in sentence D_j

and

### IDF (Inverse Document Frequency)

IDF_i=log(total number of sentences/number of sentences including term i)

are given.

A weight W_ij of the term i in a sentence j is calculated by

W_ij=TF_ij*IDF_i.

A feature vector of the sentence D_j is expressed by

Vec(D_j)=(W_1j,W_2j, . . . ,W_nj).

The degree of similarity between the sentences D_i and D_j may be calculated as the inner product of feature vectors.

s(D_i,D_j)=W_1iW_1j+W_2iW_2j+ . . . +W_niW_nj

The similar building searcher 101 calculates, by using the similarity calculator 102, the degree of similarity of the inquiry index input by the input device 201 to the index of each record recorded in the building information DB 103. Then, a record whose degree of similarity satisfies a pre-set condition is selected as a similar record. A pre-set condition is that the degree of similarity is at or above a threshold, that the degree of similarity is within a range of predetermined values, that the values of the degrees of similarity are the top N values or in the top X %, for example, but other conditions may also be used. Additionally, in the case where the number of attributes in the inquiry index is less than the number of attributes included in an index in the building information DB 103, terms related to lacking attributes may be processed as non-existent (weight is zero).

The weight of each term may be calculated in advance for each record in the building information DB 103, and may be stored, in the building information DB 103 or another storage, in association with each term in each record. In this case, when at least one of addition, deletion and update of a record is performed, the weight of a term may be re-calculated and updated.

For example, data collected by a questionnaire called Commercial Buildings Energy Consumption Survey (CBECS) regarding the attributes and energy consumption of buildings in the United States of America is used, and similarity search and calculation of various pieces of statistical data described later may be performed by using an ElasticSearch database, which is a database having a similarity search function that uses TF/IDF.

The display device 301 may display, together with a calculated degree of similarity, a similar record retrieved by the similar building searcher 101.

Here, the degree of similarity is calculated for the inquiry index

### “REGION3 CENDIV5 SQFTC7 YRCONC4 PBA2 ELUSED1 NGUSED2 FKUSED1 PRUSED2 STUSED2 HWUSED2 NFLOOR7”

with respect to each record in the building information DB 103, and a record whose degree of similarity is 1.4 or more is selected as the similar record. It is assumed that the following two similar records A and B are obtained as a result.

### Similar Record A:

Search Index=“REGION1 CENDIV1 SQFTC7 YRCONC4 PBA2 ELUSED1 NGUSED2 FKUSED1 PRUSED1 STUSED2 HWUSED2 NFLOOR7 CLIMATE1 NWKER350”
Degree of Similarity to Inquiry Index=1.4216362
Data={“ELCNS”:1846660}

### Similar Record B:

Search Index=“REGION3 CENDIV5 SQFTC7 YRCONC4 PBA2 ELUSED1 NGUSED2 FKUSED1 PRUSED2 STUSED2 HWUSED2 NFLOOR4 CLIMATE5 NWKER300”
Degree of Similarity to Inquiry Index=1.4023337
Data={“ELCNS”:10266896}

Additionally, “Data={“ELCNS”:1846660}” of the similar record A means that the data (annual electricity consumption) of the similar record is 1846660 kWh (see FIG. 2). The same thing can be said for the similar record B. Also, “PUBID” (see FIG. 2) is an ID that is unique to a building, and is different for all the records and is not used in this case.

The difference extractor 104 compares the inquiry index with the index of a similar record, and calculates the difference between the inquiry index and the index of the similar record. A term which is present in the inquiry index but not in the index of the similar record, a term which is not present in the inquiry index but is present in the index of the similar record, and a term which is present in both indices are identified by the calculation mentioned above.

In the present example, the difference between the inquiry index and the index of the similar record is as follows. In the following, [+] means a term which appears in the inquiry index but not in the index of the similar record (a first difference). [−] means a term which does not appear in the inquiry index but appears in the index of the similar record (a second difference). [=] means a term which appears in both indices.

The differences between the inquiry index and the index of the similar record A are as follows.

### [+]=[REGION3,CENDIV5,PRUSED2]

### [−]=[REGION1,CENDIV1,PRUSED1]

### [=]=[SQFTC7 YRCONC4 PBA2 ELUSED1 NGUSED2 FKUSED1 STUSED2 HWUSED2 NFLOOR7]

That is, the region, the division, and use/non-use of gas are different.

The differences between the inquiry index and the index of the similar record B are as follows.

### [+]=[NFLOOR7]

### [−]=[NFLOOR4]

### [=]=[REGION3 CENDIV5 SQFTC7 YRCONC4 PBA2 ELUSED1 NGUSED2 FKUSED1 PRUSED2 STUSED2 HWUSED2]

That is, the number of floors is different.

Based on the differences between the inquiry index (given as X) and the index of the similar record (given as Y), the corrector 105 corrects the similar record Y according to a correction rule given in advance, and generates a corrected record Y′.

In the present example, a corrected record A′ in which the differences of the index of the similar record A to the inquiry index are changed (replaced) and the data (in this case, annual electricity consumption) is changed is generated. In the same manner, a corrected record B′ in which the difference of the index of the similar record B to the inquiry index is changed and the annual electricity consumption is changed is generated.

Here, as the method of calculating data of a corrected record (in this case, annual electricity consumption), a rule that uses statistics is described as an example. The building information DB 103 is assumed to include the function of searching for a record having a specific index, and calculating statistical information of an average Avg and a variance (standard deviation) Sigma of records which are search results. This function may be provided to the corrector 105 or another processor instead of the building information DB 103.

In the following, an example procedure of the corrector 105 will be described.

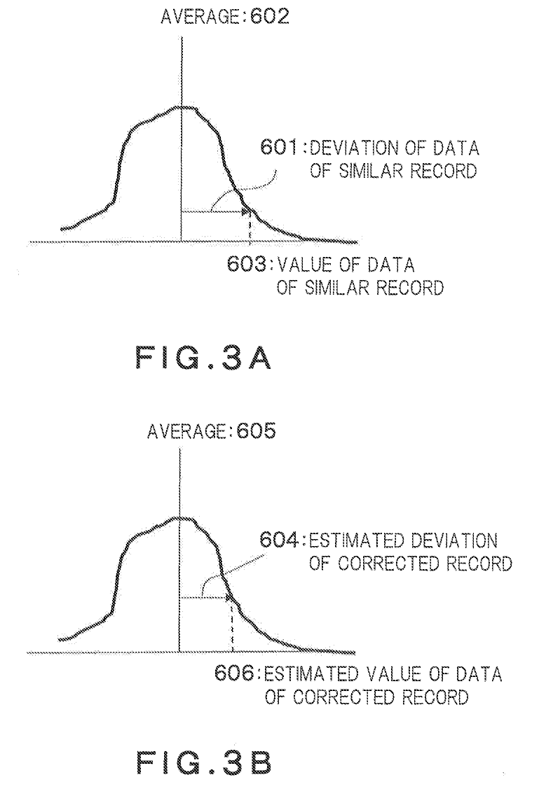

(1) In the case where a similar record includes at least one of differences [−] and [+], the following steps 1 to 5 are performed.
Step 1: A record including the difference [−] is searched for in the building information DB, and the average and the variance of the annual electricity consumption is determined based on the retrieved record.
Step 2: Using the average and the variance, the deviation of the annual electricity consumption of the similar record from the average is calculated, this is divided by the variance, and a deviation Δ ratio is calculated. The deviation Δ ratio=(annual electricity consumption−average)/variance is true. Division by the variance is performed for normalization. FIG. 3A shows an example of a deviation 601, an average 602, and annual electricity consumption 603. The deviation Δ ratio is determined by dividing the deviation 601 by the variance.
Step 3: A record including the difference [+] is searched for in the building information DB, and the average and the variance of the annual electricity consumption are determined based on the retrieved record.
Step 4: Using the average and the variance of the difference [+], the deviation of a corrected record to be generated in the next step 5 (FIG. 3B, 604) from the average is calculated from the variance and the deviation Δ ratio determined in step 3 and the average is added to the deviation, and the annual electricity consumption of the corrected record is calculated. An example of the deviation 604 is shown in FIG. 3B. An annual electricity consumption 606 is determined by adding a calculated average 605 to the deviation 604.

That is, the annual electricity consumption of corrected record=(average)+variance*deviation Δ ratio is true.

Step 5: The corrected record is generated by changing the difference [−] of the similar record to the difference [+] and rewriting the annual electricity consumption by that determined in step 4.
(2) In the case where the differences [−] and [+] are not included in a similar record, that is, in the case where the index of a retrieved similar record includes all the terms in the inquiry index, the similar record and its annual electricity consumption are determined to be used.

A specific example is given below.

When statistical calculation is performed for the similar record A with respect to [REGION1,CENDIV1,PRUSED1], which is the difference [−], the following is obtained (corresponds to step 1 described above).

“aggregations”:{“ELCNS8_stat”:{“count”:44,“min”:2614.0,“max”:9539286.0,“avg”:553779.7045454546,“sum”:2.4366307E7,“sum_of_squares”:1.09430135460269E14,“variance”:2.18037657 20214807E12,“std_deviation”:1476609.8238944102}}

Here, “count” represents the number of hits, “avg” the average, and “std_deviation” the variance (standard distribution).

On the other hand, when statistical calculation is performed for the similar record A with respect to [REGION3,CENDIV5,PRUSED2], which is the difference [+], the following is obtained (corresponds to step 3 described above).

“aggregations”:{“ELCNS8_stat”:{“count”:788,“min”:1026.0,“max”:1.94434138E8,“avg”:2743834.720812183,“sum”:2.1621417 6E9,“sum_of_squares”:8.1144898899988176E16,“variance”:9.5 44713105023123E13,“std_deviation”:9769704.757577438}}}

A desired corrected record A′ is obtained by correcting the similar record A according to steps 2, 4 and 5 described above.

First, the difference, regarding the difference [−], of the annual electricity consumption of the similar record to the average is divided by the variance, and the deviation Δ ratio is determined (corresponds to step 2 described above).

That is, the deviation Δ ratio=(annual electricity consumption−average)/variance=(1846660−553779)/1476610=0.88 is true.

Next, by using the average and the variance regarding the difference [+], the deviation from the average value (variance*deviation Δ ratio) is calculated and is added to the average, and the annual electricity consumption of the corrected record is calculated (corresponds to step 4 described above).

Annual electricity consumption of corrected record=(average)+variance*deviation Δratio=2743835+9769705*0.88=11341175.4

The corrected record A′ is obtained by changing the difference [−] in the similar record to the difference [+], and by making the annual electricity consumption the above-mentioned “11341175.4” (corresponds to step 5 described above). Accordingly, the index and the annual electricity consumption of the corrected record A′ are, respectively,

### “REGION3 CENDIV5 SQFTC7 YRCONC4 PBA2 ELUSED1 NGUSED2 FKUSED1 PRUSED2 STUSED2 HWUSED2 NFLOOR7 CLIMATE1 NWKER350”, and

11341175.4.

Likewise, a corrected record B′ is obtained from the similar record B in the following manner.

When statistical calculation is performed with respect to [NFLOOR4], which is the difference [−], the following is obtained, and the average (avg) and the variance (std_deviation) are obtained.

“aggregations”:{“ELCNS8_stat”:{“count”:276,“min”:3731.0,“max”:3.1339731E7,“avg”:2541202.4239130435,“sum”:7.0137186 9E8,“sum_of_squares”:6.076355425727525E15,“variance”:1.55 58070768696752E13,“std_deviation”:3944372.0373079353}}}

On the other hand, when statistical calculation is performed with respect to [NFLOOR7], which is the difference [+], the following is obtained, and the average (avg) and the variance (std_deviation) are obtained.

“aggregations”:{“ELCNS8_stat”:{“count”:74,“min”:4511.0,“max”:7.2195914E7,“avg”:1.0114667081081081E7,“sum”:7.484853 64E8,“sum_of_squares”:1.9695847130423508E16,“variance”:1. 6385360619596916E14,“std_deviation”:1.2800531480995981E 7}}}

First, the difference, regarding the difference [−], of the annual electricity consumption of the similar record to the average is divided by the variance, and the deviation Δ ratio is determined.

Deviation Δratio=(annual electricity consumption−average)/variance=(10266896−2541202)/3944372=1.96

Next, by using the average and the variance regarding the difference [+], the deviation from the average value (variance*deviation Δ ratio) is calculated and is added to the average, and the annual electricity consumption of the corrected record is calculated.

Annual electricity consumption of corrected record=(average)+variance*deviation Δratio=10114667+12800000*1.96=35202667.0

The corrected record B′ is obtained by changing the difference [−] in the similar record to the difference [+], and by making the annual electricity consumption “35202667.0”, which is determined in the above manner. Accordingly, the index and the annual electricity consumption of the corrected record B′ are, respectively,

### “REGION3 CENDIV5 SQFTC7 YRCONC4 PBA2 ELUSED1 NGUSED2 FKUSED1 PRUSED2 STUSED2 HWUSED2 NFLOOR7 CLIMATE5 NWKER300”, and

35202667.0.

The building information combiner 107 combines corrected records generated by the corrector 105, and generates a combined record. In the present example, the record A′ and the record B′ are combined, and a combined record C is newly generated.

In the following, an example procedure of the building information combiner 107 is described.

(Step 1) The difference between two records (difference between the terms of the indices) is calculated for corrected records generated by the corrector 105.
(Step 2) Possible combinations of terms are calculated based on the difference.
(Step 3) A record is searched for in the building information DB 103 for each of the combinations of terms, and the average value of the data (in this case, the annual electricity consumption) is calculated.
(Step 4) A combination closest (small absolute value) to the average of the annual electricity consumption of all the records in the building information DB 103 is selected.
(Step 5) One arbitrary similar record is corrected by the combination of terms selected in step 4 (the same result is obtained using any of the similar records).

A specific example is given below.

The index of the record A′, which is the corrected similar record A, is

### “REGION3 CENDIV5 SQFTC7 YRCONC4 PBA2 ELUSED1 NGUSED2 FKUSED1 PRUSED2 STUSED2 HWUSED2 NFLOOR7 CLIMATE1 NWKER350”,

and the index of the record B′, which is the corrected similar record B, is

### “REGION3 CENDIV5 SQFTC7 YRCONC4 PBA2 ELUSED1 NGUSED2 FKUSED1 PRUSED2 STUSED2 HWUSED2 NFLOOR7 CLIMATE5 NWKER300”,

and thus the differences between the two are

### [+]=[CLIMATE1,NWKER350]

### [−]=[CLIMATE5,NWKER300].

When possible combinations of terms in each of the differences are calculated, the following four are obtained.
{[CLIMATE1,NWKER350],[CLIMATE5,NWKER300],
[CLIMATE5,NWKER350],[CLIMATE1,NWKER300]}

A search in the building information DB 103 is performed for each combination (at the time of the search, CLIMATE1 may be returned to the original form, i.e., attribute=CLIMATE, value=1), and the average of the annual electricity consumption is determined by statistical calculation on the retrieved records, and the followings are obtained.

### [CLIMATE1,NWKER350]->2786202.8

### [CLIMATE5,NWKER300]->4573861.4

### [CLIMATE5,NWKER350]->3851619.0

### [CLIMATE1,NWKER300]->3387754.1

The average of the annual electricity consumption of all the records in the building information DB 103 is “3649859.3”. This value may be registered in advance in the building information DB 103, or the annual electricity consumption of all the records may be read and the average may be calculated. Of the four combinations mentioned above, the combination [CLIMATE5,NWKER350], which is the closest to the average (the absolute value of the difference is small), is selected.

Accordingly, the index of the combined record C is “REGION3 CENDIV5 SQFTC7 YRCONC4 PBA2 ELUSED1 NGUSED2 FKUSED1 PRUSED2 STUSED2 HWUSED2 NFLOOR7 CLIMATE5 NWKER350”.

The average of the annual electricity consumption “11341175.4” of the similar record A′ and the annual electricity consumption “35202667.0” of the similar record B′ is calculated, and the annual electricity consumption “23271921.2” is obtained for the combined record C.

The display device 301 displays the combined record obtained by the building information combiner 107 and the annual electricity consumption.

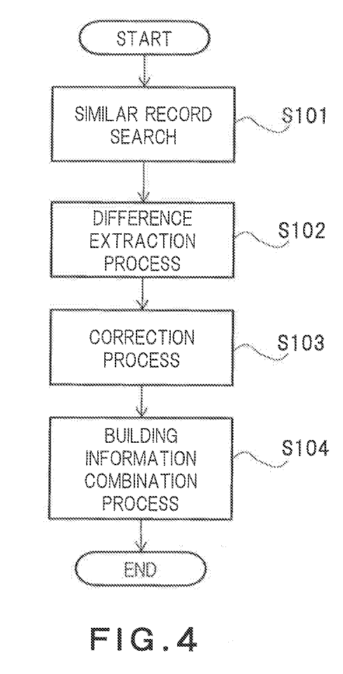

FIG. 4 shows an overall operation flow according to the present embodiment.

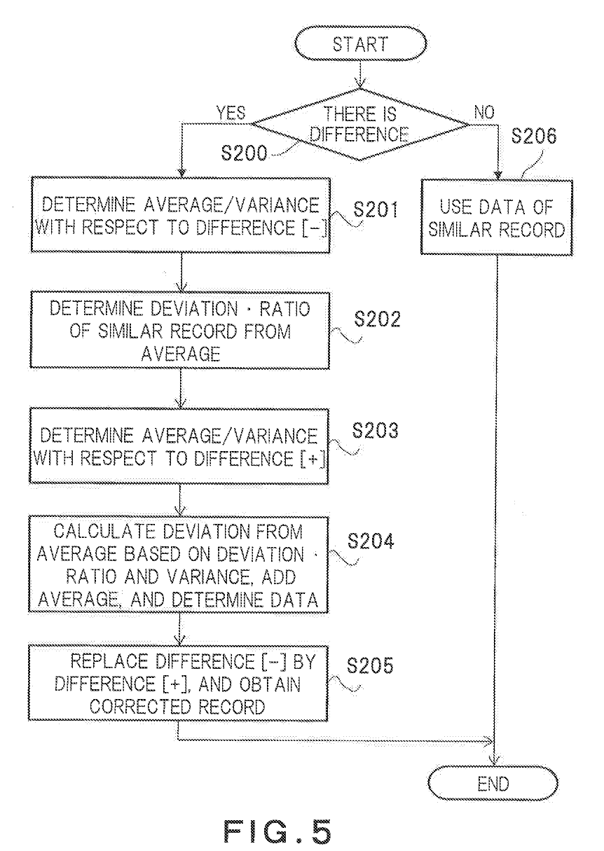

(S101) A similar record is retrieved from the building information DB 103 by the similar building searcher 101 calculating the degree of similarity for each record in the building information DB 103 based on the inquiry index input from the input device 201. The degree of similarity indicates the degree to which the inquiry index and the index of each record are approximate with each other. Of the records, a record whose degree of similarity satisfies a pre-set condition is selected as the similar record.
(S102) The difference extractor 104 calculates the difference between the index of the similar record and the inquiry index. Specifically, a term (attribute and value) which is present in the inquiry index but not in the index of the similar record is identified as the first difference ([+]), and a term (attribute and value) which is not present in the inquiry index but is present in the index of the similar record is identified as the second difference ([−]). A term which is present in both may also be identified.
(S103) The corrector 105 generates a corrected record by replacing, for the index of the similar record, the second difference ([−]) by the first difference ([+]). Also, data (in this case, annual electricity consumption) of the corrected record is calculated based on the first difference ([+]), the second difference ([−]), and each record in the building information DB 103. Generation of a corrected record and calculation of data are performed for each similar record. The flow of processing by the corrector 105 is shown in FIG. 5.

In FIG. 5, first, whether there is a difference to the similar record is determined for each term in the inquiry index (S200), and if there is a difference, steps S201 to S205 are performed.

A record including the difference [−] is searched for in the building information DB 103, and the average and the variance of the annual electricity consumption is determined based on the retrieved record(s) (S201). Using the average and the variance, the deviation Δ ratio of the annual electricity consumption of the similar record from the average is calculated (S202). The deviation Δ ratio=(annual electricity consumption−average)/variance is true. Division by the variance is performed for normalization.

A record including the difference [+] is searched for in the building information DB 103, and the average and the variance of the annual electricity consumption are determined based on the retrieved record(s) (S203).

Using the average and the variance of the difference [+], the deviation from the average is calculated based on the variance and the deviation Δ ratio determined in step 3, and the average is added to the deviation, and data (in this case, annual electricity consumption) of a corrected record to be generated in step S205 is calculated (S204). That is, the annual electricity consumption of corrected record=(average)+variance*deviation Δ ratio is true.

The corrected record is generated by changing the difference [−] of the similar record to the difference [+] and by rewriting the annual electricity consumption by that determined in step S203 (S205).

If, in step S200, there is no difference to the similar record with respect to each term in the inquiry index, data (annual electricity consumption) of the similar record may be determined to be used as it is (S206).

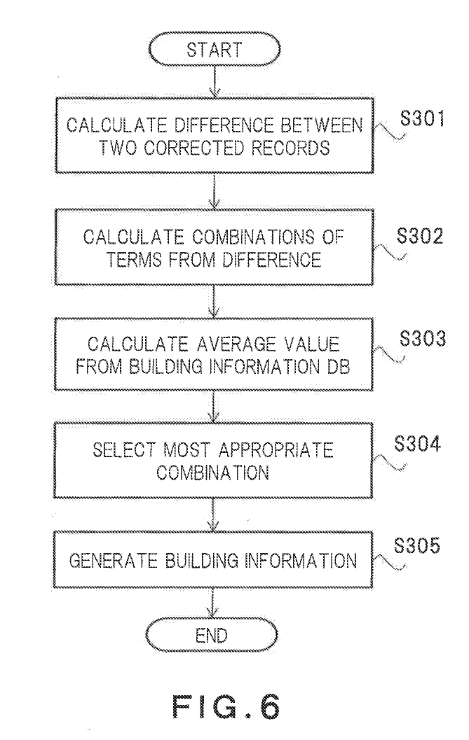

(S104 in FIG. 4) The building information combiner 107 combines corrected records, and generates a combined record. Furthermore, data (annual electricity consumption) of the combined record is calculated. The flow of processing by the building information combiner 107 is shown in FIG. 6.

All the items with at least one different term between corrected records are identified, and the terms in the identified items are obtained from each corrected record as the differences (S301).

Possible combinations of terms are calculated from the differences (S302).

A record is searched for in the building information DB 103 for each of the combinations, and the average value of the data (in this case, the annual electricity consumption) is calculated (S303).

A combination closest (small absolute value) to the average of the annual electricity consumption of all the records in the building information DB 103 is selected (S304).

Corresponding terms in one arbitrary similar record (the same result is obtained using any of the similar records) are corrected (replaced) by the selected combination of terms (S305). The average of data (in this case, annual electricity consumption) of the corrected records is calculated (S305).

Then, the display device 301 displays the combined record obtained in step S305 and the calculated average data as the solution to the inquiry index.

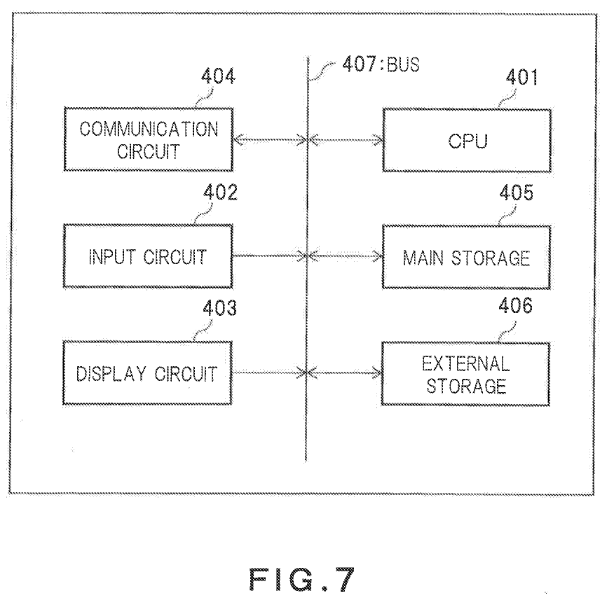

FIG. 7 shows an example hardware configuration of the building information processing device 100. The building information processing device 100 includes a CPU 401, an input circuit 402, a display circuit 403, a communication circuit 404, a main storage 405, and an external storage 406, and these are interconnected by a bus 407 in a manner capable of communication.

The input circuit 402 is a device for data input and may be an input device such as a keyboard, a mouse, and the like. The display circuit 403 controls display of data on a display device and may be the display device such as a LCD (Liquid Crystal Display) or a CRT (Cathode Ray Tube). The communication circuit 404 may include wireless or wired communication unit, and performs communication by a predetermined communication scheme.

The external storage 406 may include hardware storage media such as an HDD, an SSD, a memory device, a CD-R, a CD-RW, a DVD-RAM, a DVD-R and the like. The external storage 406 stores a program for causing the CPU 401 to perform the function of each processor in FIG. 1. Also, the building information DB 103 is included in the external storage 406. Furthermore, only one external storage 406 is shown in this case, but there may be a plurality of external storages 406.

The main storage 405 develops a control program stored in the external storage 406 under the control of the CPU 401, and stores data that is necessary at the time of execution of the program, data caused by execution of the program, and the like. The main storage 405 includes any memory such as a non-volatile memory.

As described above, according to the present embodiment, assessment of performance of a building may be made in the initial stage of consideration of design of a building, and evaluation for deciding matters regarding design is made possible. Also, the building information DB may be statistically analyzed, and a corrected record not contradictory to the overall trend may be calculated. Also, even if there is no building that is the same as the building for which search is desired to be performed, desired building information may be obtained from the records of a partially similar building (similar record).

### Second Embodiment

In the first embodiment, an example of building information including an index regarding the properties of a building and data about the annual electricity consumption of the building is described. The data is not limited to a simple scalar value such as the annual electricity consumption, and data in other forms may also be used. For example, complex data such as data having a structure that is represented by a model description for simulation may be used.

For example, a case will be considered where a model for energy simulation for a building (hereinafter “energy model”) is used as data, instead of the annual electricity consumption. As the energy model, there is an input model (IDF model) for EnergyPlus™, which is a simulator for a building, for example.

With respect to a procedure for generating a data IDF while taking a combination of an attribute indicating the property (characteristic) of a building and an attribute value as an index, the building information DB 103 is assumed to store an input model for simulation (IDF) and the index.

For example, an index is expressed in the form of
[Attribute name:value, . . . ],
   and an index in the building information DB 103 takes the following form.
[Name:name, Area:floor area, Floor:number of floors, Dir:direction, Loc:location, Zone:number of Zonez, Ac:type of air conditioner, Shape:shape]

For example, it is assumed that the following index 1 is stored in the building information DB 103:

Index 1=[Name:5ZoneBasic, Area:463.60, Floor:1, Dir:S, Loc:Chicago, Zone:5, AC:non, Shape:Square]
It is also assumed that the following data is stored corresponding to the index 1:
[“Excersize2.idf”,{ }].

Here, the data is assumed to have a structure of [IDF file name,description of procedure].

Contents of an IDF file will be described. An IDF file is a file written in text format, and includes definition information about an “object” constituting the model for energy simulation.

An “object” is defined by a category name and a combination of <attribute name,attribute value> (these are different from the attribute name and the attribute value included in an index).

The “object” is written in the following forms as the text format. Two forms are shown, and each form is shown being sandwiched by horizontally extending dashed lines “O---------------------O” at above and below.

o---------------------o

Category name,value

o---------------------o
or
o---------------------o

Category name,

Attribute value,!-Attribute name

o---------------------o

A part of “Excersize 2.idf” is shown below.

```
o---------------------o
  VERSION,8.2;
  Building,
```

| | |
|---|---|
| Exercise 2, | !- Name |
| 0.0, | !- North Axis {deg} |
| City, | !- Terrain |

| | |
|---|---|
| 0.04, | !- Loads Convergence Tolerance |

Value

| | |
|---|---|
| 0.4, | !- Temperature Convergence Tolerance |

Value {deltaC}

| | |
|---|---|
| FullInteriorAndExterior, | !- Solar Distribution |

| | |
|---|---|
| , | !- Maximum Number of Warmup |

Days

| | |
|---|---|
| 6; | !- Minimum Number of Warmup |

```
Days
  Timestep,4;
  Site:Location,
```

CHICAGO_IL_USA TMY2-94846, !- Name

o---------------------o

For example, it is indicated that the value of the object in the category “VERSION” is 8.2, and that the value of the Name attribute of the object in the category “Building” is “Exercise 2”.

Also, a plurality of objects in the same category may be defined in one file.

In the following example, there are two objects in the category “Zone”, and it is indicated that the values of Name attribute are “PLENUM” and “SOUTH PERIMETER”, respectively.

o---------------------o

Zone,

| | |
|---|---|
| PLENUM, | !-Name |
| 283.2, | !-Volume |

Zone,

| | |
|---|---|
| SOUTH PERIMETER, | !-Name |
| 239.247360229, | !-Volume |

o---------------------o

“Description of procedure” for data represents the history of corrections made on the original IDF file to obtain the IDF file.

In the following description, the “description of procedure” is assumed to be written in the following form, for example.
{“original”:X,“proc”:{a,b,c}}

Here, “a”, “b”, “c”, and “d” are assumed to be “operation description”. That the IDF data is obtained from original IDF data=X by executing operations {a,b,c} is indicated.

Here,
{a,b,c} means that the operations are performed in the order of “a”->“b”->“c”.
{a,(b|c),d}
means that the operations are performed in the order of “a”->(“b” or “c”)->“d”. Only one of “b” and “c” is performed.
{a,(b∥c),d}
means that the operations are performed in the order of “a”->(execute “b” and “c”)->“d”. Both “b” and “c” are performed in an unspecified order. “∥” means that the order of execution is such that whichever may be performed first.

Furthermore, description of the form of {“foreach”:$a,“in”:b,“proc”:{c,d})} will be described.

“$a” indicates a variable. “foreach” means that each element included in “b” is substituted for the variable “$a”, and that the process “proc:{c,d}” is performed. “b” in ““in”:b” may be a list of specific values, or may be a function formula for returning a list (for example: objByCategory(“ZONE”)).

For example,

{“foreach”:$a, “in”: [1,2,3],“proc”:{“print($a+1)”,“print($a*2)”} corresponds to
“print(1+1),print(1*2)”,
“print(2+1),print(2*2)”,
“print(3+1),print(3*2)”.

Furthermore, the “operation description” is described in the following format.

<precondition, “operation function”, postcondition>

The “operation function” takes the following forms.
add(category, object specification, value, attribute name)
alter(category, object specification, value, attribute name)
delete(category, object specification, value, attribute name).

The “object specification” is a description for specifying a specific object in the same category. An example of object specification is given below.
“#1” means the first object (counting) in the same category.
“Name==PLENUM” means an object the value of whose attribute Name is “PLENUM”.

The “value” may be a specific value (string, numerical value or the like), a variable, the variable name of “$”, or the like.

For example, with respect to an index 2
[Name:5ZoneHVAC, Area:463.60,1, Dir:S, Loc:Chicago, Floor:5, Ac:{HVAC}, Shape:Square],
   the data stored in the building information DB 103 is

[“Excersize2A.idf”,

{“original”:“Excersize2.idf”,

“proc”:{

<{ },add(“HVACTemplate:Thermostat”,#1,“Name”,“Office
Thermostat”),{ }>,

| | |
|---|---|
| <{ },add(“HVACTemplate:Thermostat”,#1,“Heating | Setpoint |

ScheduleName”, “Office Heating Setpoints”),{ }>,

| | |
|---|---|
| <{ },add(“HVACTemplate:Thermostat”,#1,“Cooling | Setpoint |

ScheduleName”, “Office Cooling Setpoints”),{ }>,
<{ }, {“foreach”:$zone, “in”:objByCategory(“Zone”),

“proc”:{

<{ },add(“HVACTemplate:Zone:VAV”,$zone.ObjN,“Zone

Name”, $zone.Name),{ }>,

<{ },add(“HVACTemplate:Zone:VAV”,$zone.ObjN,“VAV

System Name”, “VAV with Reheat”),{ }>}

}

},{ }>

}
].

Here, the “$zone.ObjN” represents the object number of “$zone”.

It is assumed that the original IDF model (“Excersize2.idf”) includes the following two Zone objects.

o---------------------o

Zone,

| | |
|---|---|
| PLENUM, | !-Name |
| 283.2, | !-Volume |

Zone,

| | |
|---|---|
| SOUTH PERIMETER, | !-Name |
| 239.247360229, | !-Volume |

o---------------------o

At this time, it is indicated that the following three objects are to be added to the original IDF model by performing an operation.

o---------------------o
HVACTemplate:Thermostat,

Office Thermostat, !-Name
Office Heating Setpoints, !-Heating Setpoint ScheduleName
Office Cooling Setpoints, !-Cooling Setpoint ScheduleName

HVACTemplate:Zone:VAV,

PLENUM, !-Zone Name
VAV with Reheat, !-VAV System Name

HVACTemplate:Zone:VAV,

SOUTH PERIMETER, !-Zone Name
VAV with Reheat, !-VAV System Name

o---------------------o

In this manner, data is stored in the building information DB 103 in the form of the original IDF model and an operation history (procedure for generating the IDF) for the same.

Also, as another example of building information, an index

[Name:5ZoneVRF, Area:463.60, Floor: 1, Dir:S,

Loc:Chicago, Zone:5, Ac:{VRF}, Shape:Square]
is given, and data thereof is as follows.
[“Excersize2B.idf”,

{“original”:“Excersize2.idf”,

“proc”:{

<{ },add(“HVACTemplate:Thermostat”,#1,“Name”,“Office
Thermostat”),{ }>,

| | |
|---|---|
| <{ },add(“HVACTemplate:Thermostat”,#1,“ Heating | Setpoint |

ScheduleName”, “Office Heating Setpoints”),{ }>,

| | |
|---|---|
| <{ },add(“HVACTemplate:Thermostat”,#1,“Cooling | Setpoint |

ScheduleName”, “Office Cooling Setpoints”),{ }>,
<{ }, {“foreach”:$zone, “in”:objByCategory(“Zone”),

“proc”:{

<{ },add(“HVACTemplate:Zone:VRF”,$zone.ObjN,“Zone

Name”, $zone.Name),{ }>,

<{ },add(“HVACTemplate:Zone:VRF”,$zone.ObjN,“VRF

System Name”, “TOSHIBA VRF”),{ }>}

}

},{ }>
}
].

Here, “objByCategory(“Zone”)” is assumed to be a function for obtaining a list of objects to be included in the category “Zone”.

Assuming that the index of “Excersize2.idf” is
[Name:5ZoneBasic, Area:463.60, Floor:F, Dir:S, Loc:Chicago, Zone:5, Ac:{ },Shape: Square], the difference between the index of “Excersize2.idf” and the index of “Excersize2A.idf” is
[+]{Ac:{HVAC}}.

In the same manner, the difference between the index of “Excersize2.idf” and the index of “Excersize2B.idf” is
[+]{Ac:{VRF}}.

Moreover, the differences between the “Excersize2A.idf” and “Excersize2B.idf” are
[+]{Ac:{VRF}}
[−]{Ac:{HVAC}}.

In this manner, operation information included in “Excersize2A.idf” and operation information included in “Excersize2B.idf” are obtained from information stored in the building information DB as correction operations corresponding, respectively, to
difference [+]{Ac:{HVAC}}, and
difference [+]{Ac:{VRF}}.

A new inquiry index for searching for a similar record (similar case) is given as below.

Inquiry Index=[Name:_, Area:_, Floor:4, Dir:S, Loc:Tokyo, Zone:_, Ac:{HVAC,VRF}, Shape:Square]

Here, “_” is a value which is not particularly specified.

As in the first embodiment, a similar record is retrieved by the similar building searcher 101, and the difference between the inquiry index and the index of the similar record is calculated by the difference extractor 104.

It is assumed that two similar records with the following indices are obtained as the similar records (similar cases).

### Index of Similar Record 1=[Name:5ZoneHVAC,Area:463.60, Floor:1, Dir:S,Loc: Chicago,Zone:5,Ac:{HVAC},Shape:Square]

### Index of Similar Record 2=[Name:5ZoneVRF,Area:463.60,Floor:1, Dir: S,Loc: Chicago,Zone:5,Ac:{VRF},Shape: Square]

The IDF model of the similar record 1 is “Excersize2A.idf”, and the IDF model of the similar record 2 is “Excersize2B.idf”.

The differences between the index of the similar record 1 and the inquiry index are

### [+][Loc:Tokyo,Floor:4,Ac:{VRF}]

### [−][Loc:Chicago,Floor:1].

The difference between the index of the similar record 2 and the inquiry index may also be calculated in the same manner.

The corrector 105 corrects the IDF model based on the difference. For example, with respect to the change of the attribute “Loc” in the similar record 1 from “Chicago” to “Tokyo”, the attribute value of the corresponding part of the corresponding IDF model is changed. In the same manner, with respect to the change of the attribute “Floor” in the similar record 1 from “1” to “4”, the attribute value of the corresponding part of the corresponding IDF model is changed.

Correction of the attribute “Ac” uses the operation information for the above-described difference [+]{Ac:{VRF}}.

That is, operation information (excerpted below) included in the data of “Excersize2B.idf” is applied to the IDF model “Excersize2A.idf” of the similar record 1.

“proc”:{

<{ },add(“HVACTemplate:Thermostat”,#1,“Name”,“Office
Thermostat”),{ }>,

| | |
|---|---|
| <{ },add(“HVACTemplate:Thermostat”,#1,“Heating | Setpoint |

ScheduleName”, “Office Heating Setpoints”),{ }>,

| | |
|---|---|
| <{ },add(“HVACTemplate:thermostat”, #1,“Cooling | Setpoint |

ScheduleName”, “Office Cooling Setpoints”),{ }>,
<{ }, {“foreach”:$zone, “in”:objByCategory(“Zone”),

“proc”:{

<{ },add(“HVACTemplate:Zone:VRF”,$zone.ObjN,“Zone

Name”, $zone.Name),{ }>,

<{ },add(“HVACTemplate:Zone:VRF”,$zone.ObjN,“VRF

System Name”, “TOSHIBA VRF”),{ }>}

}

},{ }>

}

In the same manner, operation information included in the data of “Excersize2A.idf” is applied to the IDF model “Excersize2B.idf” of the similar record 2.

In this manner, by calculating, for a similar record (similar case) retrieved, the difference between the index of the similar record and the inquiry index, and by applying operation information corresponding to the difference, the similar record may be corrected, and an IDF model corresponding to the building information for which search is desired to be performed may be obtained.

When two pieces of corrected data (in this case, IDF models) are given, the building information combiner 107 calculates combinations of corrected parts. The building information combiner 107 calculates a combined model based on the differences between the corrected IDF models. The differences between the corrected models may be presented, and a user may perform correction of the same, but in the case where the correction target is an energy model, the differences in models may be determined, and possible variations of combinations are listed based on the differences and according to the first embodiment. Each combination may be checked, by performing simulation, to find out whether the combination itself is consistent as an energy model, and simulation may be repeated until a consistent model is obtained, and a model finally combined may be obtained.

As described above, according to the present embodiment, simulation of a building may be performed in the initial stage of consideration of design of a building, and evaluation for deciding matters regarding design is made possible.

The present invention is not limited to the above described embodiments as they are, and constituent elements can be substantiated with deformation within a range not deviating from the gist thereof in a practical phase. Various inventions can be formed by appropriate combinations of the plurality of constituent elements disclosed in the above described embodiments. For example, some constituent elements can be deleted from all the constituent elements shown in the embodiments, and the elements across the different embodiments can be appropriately combined.

1. A building information processing device comprising a computer including a processor, comprising:
a building information database to store, for a plurality of buildings, a plurality of records each including an index and data, the data including values of a plurality of attributes;
a building information searcher implemented by the computer to search the building information database for first records based on an inquiry index including a value of at least one attributes among the plurality of attributes;
a difference extractor implemented by the computer to extract, with respect to each of the first records, a first difference indicating a value of the attribute that is present in the inquiry index but not in the index included in the first record, and a second difference indicating a value of the attribute that is not present in the inquiry index but is present in the index;
a corrector implemented by the computer to generate corrected indices by replacing the second difference in the index by the first difference, and to calculate data of the corrected indices based on the first difference and the second difference and by using the building information database; and
a building information combiner implemented by the computer to generate a combined index by combining the corrected indices, and to calculate data for the combined index based on the data of the corrected indices.

2. The building information processing device according to claim 1, wherein the corrector
retrieving records including the second difference from the building information database, calculating a first average and a first variance that are an average and a variance of data of the retrieved records, and dividing a difference between data of the first record and the first average by the first variance to calculate a first value, and
retrieving records including the first difference from the building information database, calculating a second average and a second variance that are an average and a variance of data of the retrieved records, multiplying the second variance and the first value, and adding the second average to calculate the data of the corrected index.

3. The building information processing device according to claim 1, wherein the building information combiner
identifies the attributes in which values of the attributes are different between the corrected indices,
combining the values of the attributes among the identified attributes,
retrieving records from the building information database for each combination of the values of the attributes,
calculating a representative value of data of the retrieved records,
selecting one of the combinations based on each calculated representative value, and
replacing the values of the identified attributes of one the corrected indices by the selected combination to generates the combined index.

4. The building information processing device according to claim 3, wherein the building information combiner selects the one combination by comparing a representative value of the data of the records in the building information database with each calculated representative value.

5. The building information processing device according to claim 4, wherein the building information combiner selects the one combination in which the representative value of the retrieved records has a closest value to the representative value of the data of the records in the building information database.

6. The building information processing device according to claim 4,
wherein the representative value of the data of the records in the building information database is an average value of the data of the records, and
wherein each calculated representative value is an average value of the data of the retrieved records.

7. A building information processing method performed by a computer, comprising:
reading a building information database to store, for a plurality of buildings, a plurality of records each including an index and data, the data including values of a plurality of attributes;
searching the building information database for first records based on an inquiry index including a value of at least one attributes among the plurality of attributes;
extracting, with respect to each of the first records, a first difference indicating a value of the attribute that is present in the inquiry index but not in the index included in the first record, and a second difference indicating a value of the attribute that is not present in the inquiry index but is present in the index;
generating corrected indices by replacing the second difference in the index by the first difference, and to calculate data of the corrected indices based on the first difference and the second difference and by using the building information database; and
generating a combined index by combining the corrected indices, and to calculate data of the combined index based on the data of the corrected indices.

8. A non-transitory computer readable medium having a program stored therein which, when executed by a computer, causes the computer to perform processing, comprising:
reading a building information database to store, for a plurality of buildings, a plurality of records each including an index and data, the data including values of a plurality of attributes;
searching the building information database for first records based on an inquiry index including a value of at least one attributes among the plurality of attributes;
extracting, with respect to each of the first records, a first difference indicating a value of the attribute that is present in the inquiry index but not in the index included in the first record, and a second difference indicating a value of the attribute that is not present in the inquiry index but is present in the index;
generating corrected indices by replacing the second difference in the index by the first difference, and to calculate data of the corrected indices based on the first difference and the second difference and by using the building information database; and
generating a combined index by combining the corrected indices, and to calculate data of the combined index based on the data of the corrected indices.
